(19) United States
(12) Patent Application Publication
(10) Pub. No.: US 2011/0286124 A1
(43) Pub. Date: Nov. 24, 2011

(54) MAGNETIC RECORDING MEDIUM AND MAGNETIC RECORDING MEDIUM MANUFACTURING METHOD

(75) Inventor: Narumi SATO, Minami-alps-city (JP)

(73) Assignee: Fuji Electric Device Technology Co., Ltd., Tokyo (JP)

(21) Appl. No.: 13/024,311

(22) Filed: Feb. 9, 2011

(30) Foreign Application Priority Data
May 20, 2010 (JP) 2010-116472

(51) Int. Cl. G11B 5/86

(52) U.S. Cl. 360/16; G9B/5.308

(57) ABSTRACT

In a magnetic recording medium and magnetic recording medium manufacturing method, it is possible to easily separate a conjoined body without carrying out shape processing in a transfer master in order to separate a conjoined body, and without scratching the magnetic recording medium in a separating step. Moreover, it is possible to mass-produce the magnetic recording medium efficiently without increasing the size of a device. As the central portion of a transfer master is caused to bow convexly in an upward direction, in a condition in which a press receiving surface portion of the transfer master is restrained by a pressing surface of a pressing member, the outer periphery of a magnetic recording medium in a conjoined body is easily separated from a transfer receiving medium contact region of the transfer master in such a way that a predetermined gap is formed.

### CROSS-REFERENCE TO RELATED APPLICATION

This application claims priority under 35 U.S.C. §119 from Japanese Patent Application No. 2010-116472, filed on May 20, 2010, the entirety of which is incorporated herein by reference.

### BACKGROUND OF THE INVENTION

1. Technical Field

The present invention relates to a magnetic recording medium manufactured via a magnetic transfer step, and to a magnetic recording medium manufacturing method.

2. Related Art

A writing of magnetic information onto a magnetic recording medium is generally such that, after a magnetic recording medium is installed in a hard disk drive (hereafter also referred to as an HDD device) in a condition in which no magnetic information is written onto its recording surface, the necessary magnetic information is written into a region of concentric circles with constant widths called tracks on the recording surface of the magnetic recording medium in the HDD device. A reading or writing of data on the magnetic recording medium is carried out while a magnetic head moves along the tracks. At this time, a misalignment of the magnetic head with respect to the tracks is detected based on a magnetic signal called a servo signal written into the tracks of the magnetic recording medium. The magnetic head is controlled, based on the servo signal, so as not to deviate from the tracks.

In order to precisely write, for example, a servo signal in the concentrically circular tracks on a magnetic recording medium onto which no item of data is written, it is necessary to introduce from the exterior, for each HDD device, a device having a function of precisely controlling the position of the magnetic head in the tracks. Also, for example, it may be the case that several hours are needed in order to write the servo signal into the several hundreds of thousands of tracks formed on one recording surface of the magnetic recording medium.

Furthermore, as well as a position control device of still higher accuracy becoming necessary for the HDD device along with the recent improvement in recording density on the magnetic recording medium, the servo signal writing time has become longer. Consequently, this has become a considerable disadvantage from the aspects of HDD device productivity and cost.

Therefore, a magnetic transfer technique that transfers the servo signal pattern of a transfer master having the servo signal pattern to a magnetic recording medium has been developed, as also shown in, for example, JP-A-H11-025455, JP-A-2003-173523, and JP-A-2004-134012. This kind of technique is such that, in a condition in which a transfer master having a servo signal pattern is brought into close contact with a magnetic recording medium, magnetic information corresponding to the servo signal pattern is instantaneously transferred to the magnetic recording medium by applying a magnetic field from the exterior to the transfer master and magnetic recording medium in contact with each other. With this technique, a reduction in manufacturing cost and a higher track density (a narrowing of the track width) is possible.

With the heretofore described magnetic transfer technique, after the magnetic information corresponding to the servo signal pattern is instantaneously transferred to the magnetic recording medium, it is necessary to cause the transfer master and magnetic recording medium to which the transfer has been made to separate swiftly, and without damage, in order to obtain the magnetic recording medium to which the transfer has been made.

As also shown in JP-A-H11-025455, a first separation method is a method whereby the magnetic recording medium to which the transfer has been made is separated from the transfer master by introducing a predetermined air pressure, via a chamber and air hole provided in the transfer master, between the magnetic recording medium to which the transfer has been made (called a slave disk in JP-A-H11-025455) and the transfer master (called a master in JP-A-H11-025455.

Also, as also shown in JP-A-2003-173523, a second separation method is a method whereby, after the leading edge portion of a claw of a detaching unit is inserted into a gap caused by a ring-like depressed portion formed between the outer peripheral portion of the magnetic recording medium to which the transfer has been made (called a slave medium in JPA-2003-173523) and the outer peripheral portion of the transfer master (called a master carrier in JP-A-2003-173523), the magnetic recording medium is pulled up away from the transfer master, causing the magnetic recording medium to become detached.

Furthermore, as also shown in JP-A-2004-134012, a third separation method is a method whereby the magnetic recording medium is separated from the transfer master by a compressed fluid being poured onto the contact surfaces of the magnetic recording medium to which the transfer has been made (called a slave medium in JP-A-2004-134012) and the transfer master (called a master carrier in JP-A-2004-134012), and the gripping claw of a chuck holding the inner peripheral portion of the magnetic recording medium and simultaneously applying a detaching external force.

(1) When a chamber and air hole are provided in the transfer master, as shown in JP-A-H11-025455, steps of machining them increase, meaning that the manufacturing cost balloons. Also, by a chamber for pumping a gas being provided, it may happen that the device becomes large and complex.

(2) Also, when a ring-like depressed portion is formed between the outer peripheral portion of the magnetic recording medium to which the transfer has been made and the outer peripheral portion of the transfer master, as shown in JP-A-2003-173523, it may happen that the upper end portion edge of the depressed portion comes into contact with the transfer receiving surface of the magnetic recording medium. As a result of this, it may happen that a contact mark following the shape of the edge, contaminants caused by edge chipping, or friction contaminants or scratches caused by a jig insertion are detected on the transfer receiving surface of the detached magnetic recording medium. There is a danger that articles of sufficient size to cause a problem with the levitation of the magnetic head are also included in the contaminants.

(3) Furthermore, when the magnetic recording medium is detached by the gripping claw of a chuck in a condition in which a compressed fluid is poured onto the contact surfaces, as shown in JP-A-2004-134012, there is a danger of a problem of a contact mark arising due to the inner peripheral edge of the transfer master coming into contact with the magnetic recording medium, as well as which, it may happen that the outer peripheral edge of the magnetic recording medium scratches the transfer master when it is detached by the gripping claw of the chuck.

Then, for example, when the magnetic transfer step and conjoined body separating step are carried out in one device, it is not possible to carry out a new magnetic transfer onto another magnetic recording medium during the separating of the conjoined body, meaning that the magnetic recording media accumulate. Consequently, when consecutively producing a large number of magnetic recording media, there is an accompanying problem in that it is necessary to handle this by installing a large number of this kind of device.

### SUMMARY OF THE INVENTION

Bearing in mind the above problems, firstly, the invention has an object of providing a magnetic recording medium and magnetic recording medium manufacturing method whereby it is possible to easily separate a conjoined body with no need to carry out ventilation duct processing in order to separate the conjoined body in the kind of transfer master described in (1), above, and moreover, without scratching the magnetic recording medium in the separating step. Also, secondly, the invention has an object of providing a magnetic recording medium and magnetic recording medium manufacturing method without the kind of danger described in (2), above of generating scratches or contaminants in the transfer master or transfer receiving body. Furthermore, thirdly, the invention has an object of providing a magnetic recording medium and magnetic recording medium manufacturing method whereby, in the case of large-volume production described in (3), above, it is possible to mass-produce efficiently without increasing the size of the device, and consequently, to reduce the device configuration and processing time.

In order to achieve the heretofore described objects, a magnetic recording medium manufacturing method according to one aspect of the invention includes a step of forming a conjoined body including a transfer master on which magnetic transfer information is recorded, and a transfer receiving medium, and a separating step causing the transfer receiving medium in the conjoined body to separate from the transfer master, wherein the transfer receiving medium is caused to separate from the transfer master in the separating step by pressing at least one of the outer peripheral edge portion and central portion of the transfer master, causing the transfer master to bow in a convex form.

Also, with the magnetic recording medium manufacturing method according to the aspect of the invention, the resilience of the transfer receiving medium arising in accordance with the bending moment acting on the transfer master of the conjoined body may be greater than the adherence between the transfer master and transfer receiving medium.

Furthermore, a magnetic recording medium according to one aspect of the invention is manufactured by using the magnetic recording medium manufacturing method.

According to the magnetic recording medium and magnetic recording medium manufacturing method according to the aspects of the invention, as the transfer receiving medium is caused to separate from the transfer master in the separating step by pressing at least one of the outer peripheral edge portion and central portion of the transfer master, causing the transfer master to bow in a convex form, it is possible to easily separate in the separating step without scratching the magnetic recording medium, and moreover, it is possible to efficiently mass-produce without increasing the size of the device. Also, as the transfer receiving medium is easily detached by the resilience of the transfer receiving medium arising in accordance with the bending moment acting on the transfer master of the conjoined body being greater than the adherence between the transfer master and transfer receiving medium, there is no need to carry out shape processing in the transfer master in order to separate the conjoined body.

### BRIEF DESCRIPTION OF THE DRAWINGS

FIG. 1 is a configuration diagram schematically showing a configuration of a first embodiment of a separating device in a production system of a magnetic recording medium to which one example of a magnetic recording medium manufacturing method according to the invention is applied;

FIG. 2 is a perspective view showing each component in the example shown in FIG. 1 disassembled;

FIG. 3 is a perspective view showing a conjoined body formation device in the production system of the magnetic recording medium to which is applied one example of the magnetic recording medium manufacturing method according to the invention, together with a transfer master and magnetic recording medium;

FIGS. 4A and 4B are each diagrams accompanying an operational description of the conjoined body formation device shown in FIG. 3;

FIG. 5 is a plan view showing the transfer master used in the example shown in FIG. 1;

FIG. 6 is a perspective view schematically showing a configuration of a magnetic transfer device in the production system of the magnetic recording medium to which is applied one example of the magnetic recording medium manufacturing method according to the invention;

FIG. 7 is a perspective view accompanying a description of an edge transfer method principle showing a partially enlarged partial cross-section of a conjoined body;

FIG. 8 is a perspective view accompanying a description of a bit transfer method principle showing a partially enlarged partial cross-section of a conjoined body;

FIG. 9 is a characteristic diagram accompanying the description of the edge transfer method principle showing an enlargement of one portion of a magnetic signal;

FIG. 10 is a block diagram showing a control unit included in the example shown in FIG. 1;

FIGS. 11A to 11D are configuration diagrams accompanying an operational description of the example shown in FIG. 1;

FIG. 12 is a diagram accompanying a description of steps of the production system of the magnetic recording medium to which is applied one example of the magnetic recording medium manufacturing method according to the invention;

FIGS. 13A to 13D are configuration diagrams accompanying an operational description of a second embodiment of the separating device in the production system of the magnetic recording medium to which is applied one example of the magnetic recording medium manufacturing method according to the invention;

FIG. 14 is a configuration diagram accompanying an operational description of a third embodiment of the separating device in the production system of the magnetic recording medium to which is applied one example of the magnetic recording medium manufacturing method according to the invention;

FIG. 15 is a perspective view showing each component in the example shown in FIG. 14 disassembled;

FIGS. 16A to 16D are configuration diagrams accompanying an operational description of the example shown in FIG. 14;

FIG. 17 is a configuration diagram showing a case in which another example of a transfer master is applied in the example shown in FIG. 1;

FIG. 18 is a configuration diagram showing a case in which another example of a transfer master is applied in the example shown in FIG. 13A;

FIG. 19 is a configuration diagram showing a case in which another example of a transfer master is applied in the example shown in FIG. 14;

FIG. 20 is a perspective view showing still another example of a transfer master together with the magnetic recording medium;

FIGS. 21A and 21B are each configuration diagrams showing a separating device in a comparison example;

FIG. 22 is a plan view showing a transfer master used in the example shown in FIGS. 21A and 21B;

FIG. 23 is a perspective view showing a heretofore known magnetic transfer device as another comparison example; and

FIG. 24 is a diagram accompanying a description of steps of the other comparison example.

### DETAILED DESCRIPTION

### First Embodiment

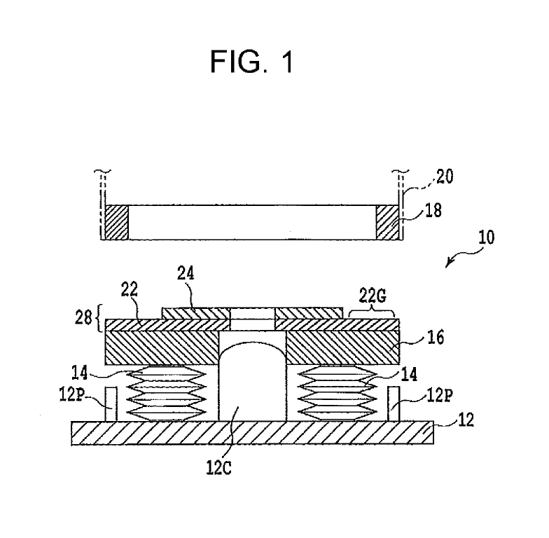

FIG. 1 schematically shows a configuration of a first embodiment of a separating device disposed in an operating station (hereafter also called a separating station) in a production system of a magnetic recording medium to which is applied one example of a magnetic recording medium manufacturing method according to the invention. A separating step of separating a conjoined body obtained through a series of manufacturing steps into a transfer master and a transfer receiving medium is carried out in the separating station. Also, the separating step is a step carried out after going through a conjoined body formation step and magnetic transfer step carried out respectively in a conjoined body formation station and magnetic transfer station, to be described hereafter. The conjoined body formation station and magnetic transfer station acting as operating stations are disposed along a magnetic recording medium conveyor path shared with a magnetic recording medium conveyor path provided for the separating station in the production system.

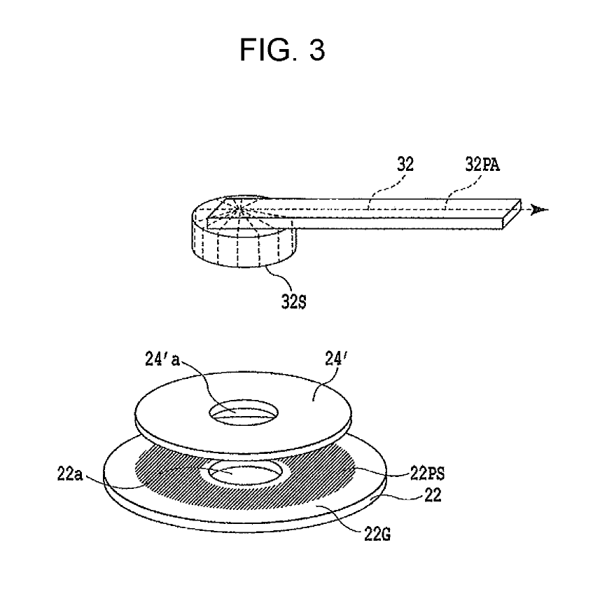

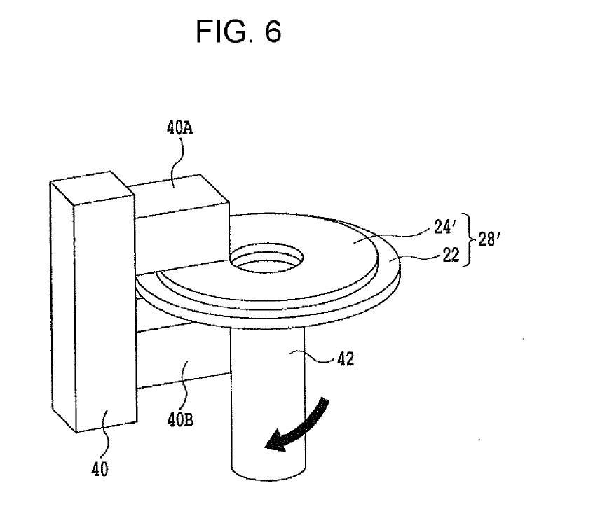

Referring to FIG. 6, a conjoined body 28′ is obtained after a magnetic recording medium disc 24′, as the transfer receiving medium, and a transfer master 22 are brought into contact by a conjoined body formation device, to be described hereafter. Magnetic signals are transferred by a magnetic transfer device to a recording surface of the magnetic recording medium disc 24′ in an obtained conjoined body 28′, as shown in, for example, FIGS. 3 and 6. Finally, the conjoined body 28 (see FIG. 1) is obtained.

Referring to FIG. 3, the magnetic recording medium disc 24′ is made from a material such as glass, aluminum, silicon, or plastic, and has a circular hole 24′a in its central portion. The outer diameter and inner diameter of the magnetic recording medium disc 24′ are set at, for example, 65 mm and 20 mm respectively.

The magnetic recording medium disc 24′ is such that a magnetic layer, and a protective layer above that, are stacked by sputtering on, for example, an amorphous glass base material. Also, a lubricant is applied to the protective layer.

The dimensions of the magnetic recording medium disc 24′, not being limited to such an example, are not limited to the heretofore mentioned values, provided that, for example, they are smaller than the outer diameter of the transfer master 22, to be described hereafter, and coincide with the size of a transfer receiving medium contact region provided on the transfer master 22.

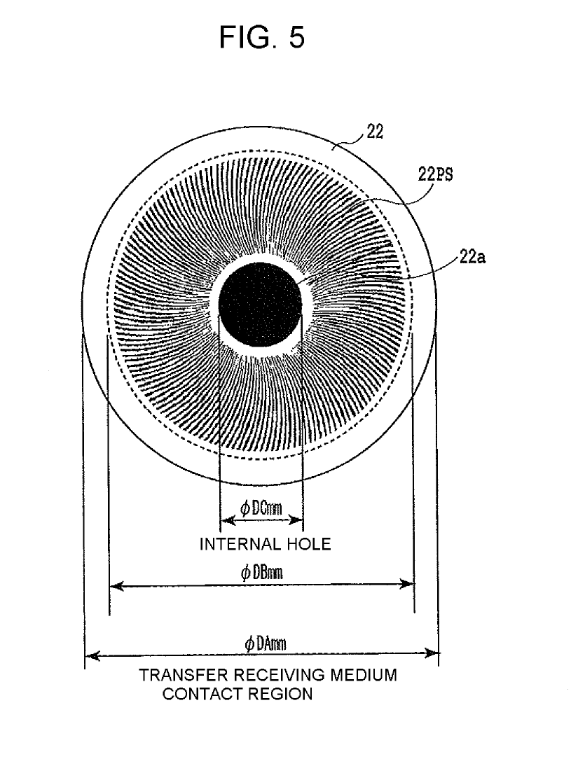

The transfer master 22 of thickness 0.5 mm is made in a ring form from a material such as silicon, glass, aluminum, or plastic, and has a circular hole 22a in its central portion. An outer diameter ΦDA and inner diameter ΦDC of the transfer master 22 are set at 80 mm and 20 mm respectively, as shown enlarged in FIG. 5. Also, a transfer receiving medium contact region 22PS is formed in a ring form extending from the periphery of the hole 22a toward the outer edge of the transfer master 22 on a transfer surface of the transfer master 22. A diameter ΦDB of the transfer receiving medium contact region 22PS is set at, for example, 65 mm. The transfer receiving medium contact region 22PS has a transfer pattern formation surface configured of a plurality of arcs extending radially at predetermined intervals in a circumferential direction from the inner periphery to the outer periphery. In FIG. 5, a microscopic pattern corresponding to magnetic transfer information is formed from, for example, a soft magnetic body in each portion describing a black arc in the transfer pattern.

As a method of fabricating the transfer master 22, for example, an FeCo based soft magnetic layer and a protective layer formed from carbon are deposited by sputtering on a silicon substrate. Subsequently, after a resist is applied to the protective layer, a microscopic pattern is replicated on the surface of the resist by a nickel (Ni) stamper, on which is formed a microscopic pattern corresponding to a predetermined servo signal pattern, being pressed against the surface of the resist formed. After the resist is etched by dry etching, the microscopic pattern is formed by ion milling in the soft magnetic layer. The transfer master is obtained by the resist and protective layer formed from carbon being removed by another dry etching. The grooves and lands formed in the microscopic pattern obtained are of, for example, approximately 30 nm.

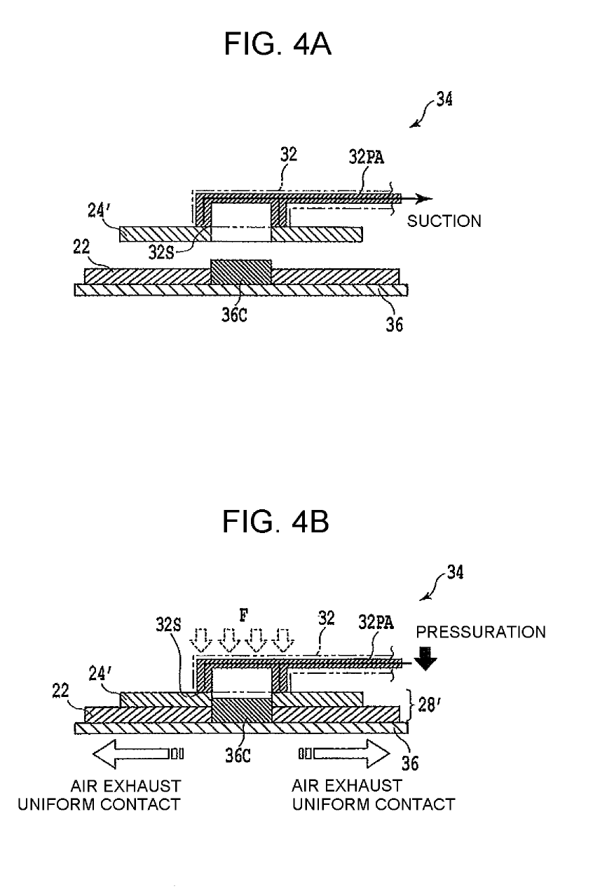

The recording surface of the magnetic recording medium disc 24′ is brought into contact with the transfer receiving medium contact region 22PS by the conjoining device shown in FIGS. 3, 4A and 4B.

A ring-like portion formed adjacent to the transfer receiving medium contact region 22PS, in the outer peripheral edge portion thereof, shown in FIG. 3 is a press receiving surface portion 22G which is brought into contact with a ring-like pressing surface of a pressing member 18 (see FIG. 1). The inner dimensions and outer dimensions of the press receiving surface portion 22G are preferably set so that there is a holding portion of approximately 2% or more of the diameter of the transfer master 22. An arrangement may be such that, after the holding portion is set with width to spare, one portion of the outer edge of the press receiving surface portion 22G is pressed with the ring-like pressing surface of the pressing member 18.

The dimensions of the transfer master 22, not being limited to such an example, may be determined as appropriate in accordance with the dimensions of the transfer receiving medium, the device configuration, and the like.

Referring to FIGS. 4A and 4B, the conjoined body formation device, as well as being disposed in the conjoined body formation station acting as the operating station and having a cylindrical portion 36C in the central portion, is configured including, as main elements, a base 36 having a mounting surface on the periphery of the cylindrical portion 36C on which the transfer master 22 is mounted, a pressurizing mechanism 34 formed including a conveyor handler 32 having a gripping surface portion 32S that selectively adsorbs or releases the magnetic recording medium disc 24′, and a pneumatic cylinder (not shown) that supports the conveyor handler 32 in such a way that it can move up and down, as shown in FIG. 4A.

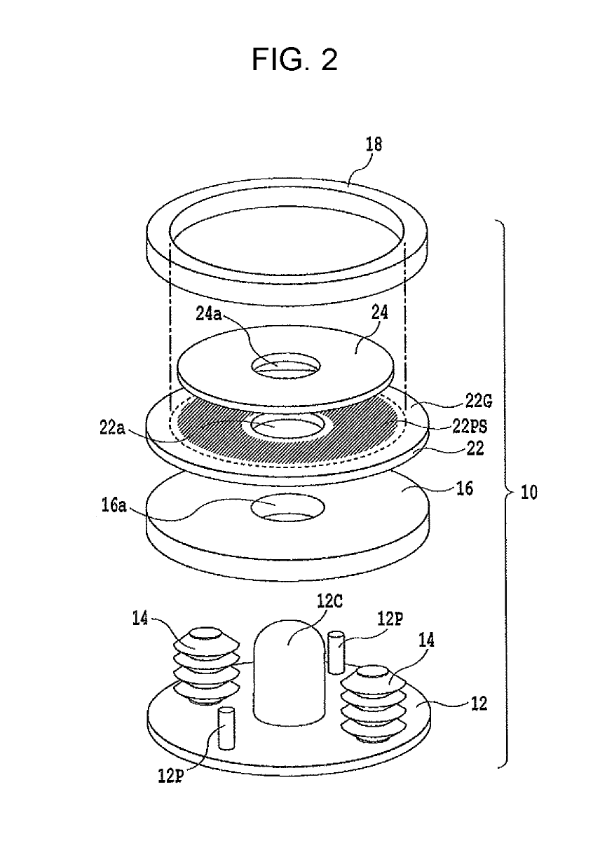

The transfer master 22 and magnetic recording medium disc 24′ are sequentially stacked on the mounting surface of the base 36 in a condition in which the cylindrical portion 36C provided perpendicularly with respect to the mounting surface is inserted in the holes 22a (see FIG. 2, e.g.) and 24′a. The height from the mounting surface to the topmost end of the cylindrical portion 36C is set slightly lower than the total of the thicknesses of the transfer master 22 and magnetic recording medium disc 24′. Also, the central position of the hole 24′a of the magnetic recording medium disc 24′ and the central position of the hole 22a of the transfer master 22, into which the cylindrical portion 36C is inserted, being on a common central axis line, the diameter of the cylindrical portion 36C is set so as to form approximately the same gap with respect to the inner peripheral portion in each hole. Consequently, the positioning of the magnetic recording medium disc 24′ with respect to the transfer receiving medium contact region 22PS of the transfer master 22 is carried out by the cylindrical portion 36C. The positioning of the magnetic recording medium disc 24′ with respect to the transfer receiving medium contact region 22PS of the transfer master 22 may also be carried out with the further provision of a positioning pin engaged in the holes of the magnetic recording medium disc 24′ and transfer master 22. Also, the positioning of the magnetic recording medium disc 24′ with respect to the transfer receiving medium contact region 22PS of the transfer master 22 may also be carried out with a configuration wherein a positioning mark is provided on the outer peripheral edge of the transfer master 22, and a detector that detects the positioning mark is provided in the conveyor handler 32.

The gripping surface portion 32S of the conveyor handler 32 selectively comes into contact with and grips the vicinity of the periphery of the hole 24′a of the magnetic recording medium disc 24′, as shown in FIG. 4A. The gripping surface portion 32S has a plurality of through holes communicating with one end of an operating pressure supply passage 32PA formed inside the conveyor handler 32. A vacuum pump, which is omitted from the drawing, is connected as an adsorption unit to the other end of the operating pressure supply passage 32PA.

Also, when the vacuum pump is put into an operating condition, the pneumatic cylinder that supports the conveyor handler 32 in such a way that it can move up and down is controlled by a drive controller, omitted from the drawing, in such a way as to move between a waiting position, in which the magnetic recording medium disc 24′ held by the gripping surface portion 32S of the conveyor handler 32 is kept apart from the transfer master 22, as shown in FIG. 4A, and a pressing position, in which the magnetic recording medium disc 24′ held by the gripping surface portion 32S is pressed against the transfer master 22 with a predetermined pressurizing force F, as shown in FIG. 4B.

With such a configuration, when the vacuum pump is put into the operating condition after the transfer master 22 is stacked on the mounting surface of the base 36, as shown in FIG. 4A, the inner peripheral region of the recording surface of the magnetic recording medium disc 24′ made concentric with and held by the gripping surface portion 32S of the conveyor handler 32 is superimposed on the transfer receiving medium contact region 22PS of the transfer master 22, and pressed against it at a pressurizing force of, for example, 6.5 kg/cm2 for a holding period of five seconds by means of the pneumatic cylinder, as shown in FIG. 4B.

By this means, air included in the space between the transfer receiving medium contact region 22PS of the master 22 and the recording surface of the disc 24′ is forced out toward the outer periphery. Consequently, the two are brought into even, overall close contact, and the conjoined body 28′ is formed. As the master 22 and disc 24′ are in close contact, even when the pneumatic cylinder stops the pressurization with the conveyor handler 32, the conjoined body 28′ maintains the conjoined condition. The heretofore described conjoining method is one example and, not being limited to such an example, the conjoining may be carried out as appropriate using another suitable method. Also, another drive unit, such as a motor, may be used in place of the pneumatic cylinder as a pressurization drive unit that pressurizes the magnetic recording medium disc 24′.

Next, predetermined magnetic signals are transferred to the recording surface of the magnetic recording medium disc 24′ in the obtained conjoined body 28′ by the magnetic transfer device shown in FIG. 6, as will be described hereafter.

In FIG. 6, the magnetic transfer device in which a magnetic transfer is carried out using, for example, a bit transfer method is configured including a spindle 42 that is rotatably supported in a housing, omitted from the drawing, and that detachably supports at one end the conjoined body 28′ via a suction gripping mechanism (not shown), electromagnets 40A and 40B that form a magnetic field in a perpendicular direction with respect to the conjoining surfaces (contact surfaces) of the conjoined body 28′, and a drive control mechanism 40 that controls the movement of the electromagnets 40A and 40B in such a way that they can approach or withdraw from each other. One end of the spindle 42 is linked to the output shaft of a drive motor, omitted from the drawing. The drive control mechanism 40 is controlled by a controller, omitted from the drawing.

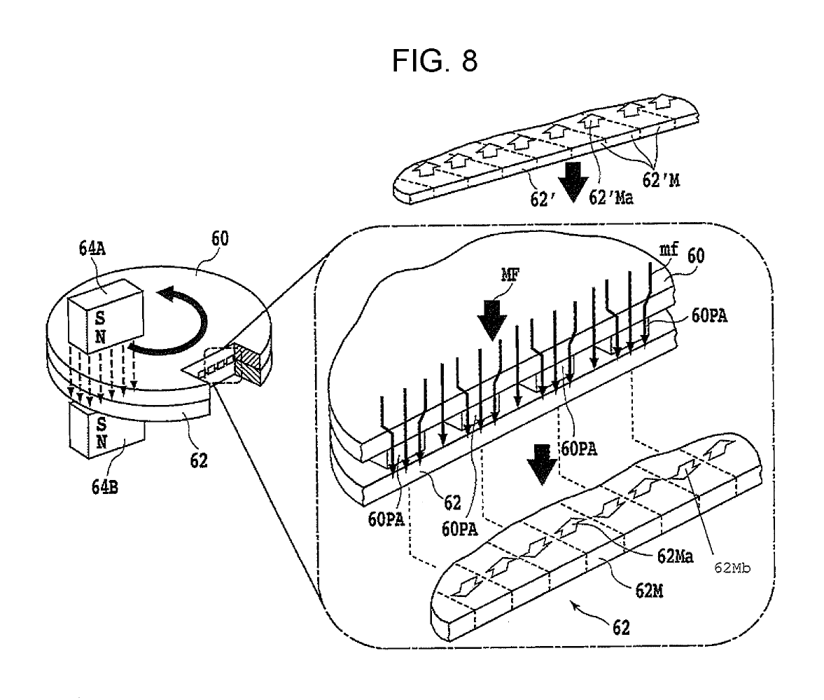

Referring to FIG. 8, in the case of the bit transfer method, in principle, firstly, a magnetic layer 62′M of a transfer receiving medium 62′ is magnetized in advance, before a transfer, in the direction indicated by arrows 62′Ma, that is, in one direction, as schematically shown enlarged in FIG. 8. Next, by the transfer receiving medium 62′ being magnetized, and the magnetic signals being transferred, while a conjoined body configured of a transfer master 60 and the transfer receiving medium 62′ is rotated between electromagnets 64A and 64B in the magnetic transfer device, a transfer receiving medium 62 onto which the transfer has been carried out is obtained.

During the transfer onto the transfer receiving medium 62, a magnetic field is applied in the direction indicated by an arrow MF, that is, in a perpendicular direction, with respect to the contact surfaces of the transfer master 60 and transfer receiving medium 62. Because of this, as a large amount of magnetic flux passes through in the direction indicated by arrows mf in each soft magnetic body microscopic pattern 60PA of the transfer master 60, a magnetic layer 62M corresponding to the microscopic patterns 60PA in the transfer receiving body 62 is magnetized in the direction indicated by arrows 62Mb, which is the opposite of the initial direction of magnetization indicated by arrows 62Ma. However, in portions not in contact with the microscopic patterns 60PA, the initial direction of magnetization is maintained. The soft magnetic body microscopic patterns may be such that a soft magnetic body is formed as a projecting portion on a main surface of the transfer master, or may be of a form wherein a soft magnetic body is embedded in a depressed portion formed in a main surface of the transfer master.

In FIG. 6, firstly, after the conjoined body 28′ is supported at the one end of the spindle 42 via the suction gripping mechanism (not shown), the electromagnets 40A and 40B are brought toward each other as far as predetermined positions on either side of the conjoined body 28′. Then, when a drive motor is put into an operating condition, the spindle 42 is caused to rotate together with the conjoined body 28′ through one rotation at a rotation speed of, for example, two seconds or more, twenty seconds or less per rotation, for example, a rotation speed of ten seconds per rotation. By this means, the magnetic signals are transferred over the whole of the recording surface of the magnetic recording medium disc 24′ in the conjoined body 28′, as heretofore described. Consequently, the conjoined body 28 including a magnetic recording medium disc 24 to which the transfer has been made is obtained.

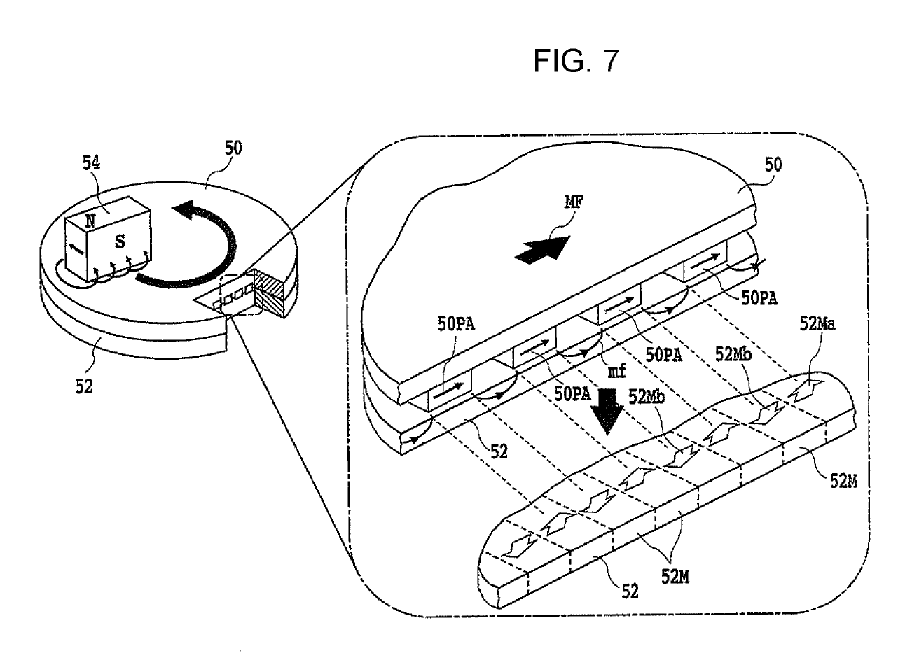

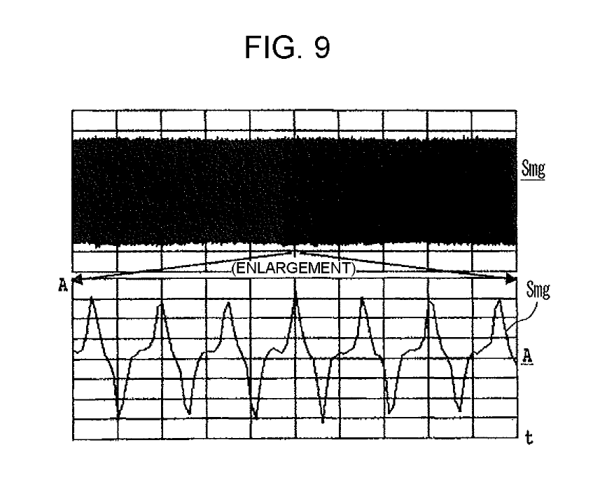

The transfer method of the magnetic transfer device not being limited to the bit transfer method, a magnetic transfer device (not shown) in which a magnetic transfer is carried out using, for example, an edge transfer method may also be used. Referring to FIG. 7, the edge transfer method is a method whereby a magnetic field is applied in an in-plane direction of a transfer master 50 having a plurality of microscopic patterns 50PA corresponding to magnetic transfer information, and a magnetic layer 52M of a transfer receiving medium 52 is magnetized along the perpendicular component of leakage flux emanating from edge portions of the patterns, as schematically shown enlarged in FIG. 7, thereby recording the magnetic information. In the device, when an external magnetic field is applied by an electromagnet 54 in the direction indicated by an arrow MF while a conjoined body including the transfer master 50 and transfer receiving medium 52 is rotated in the direction of the arrow, the magnetic layer 52M of the transfer receiving medium 52 is magnetized in the direction indicated by an arrow 52Ma and the direction indicated by an arrow 52Mb, depending on the direction of the perpendicular component of leakage flux mf emanating from the edge portion of each of the microscopic patterns 50PA. Consequently, this method is such that the magnetic signals are transferred by the magnetic flux leaking from the edges of the soft magnetic body microscopic patterns 50PA of the transfer master 50. A kind of magnetic signal Smg, shown partially enlarged in FIG. 9, transferred onto the transfer receiving medium 52 is, for example, a servo signal.

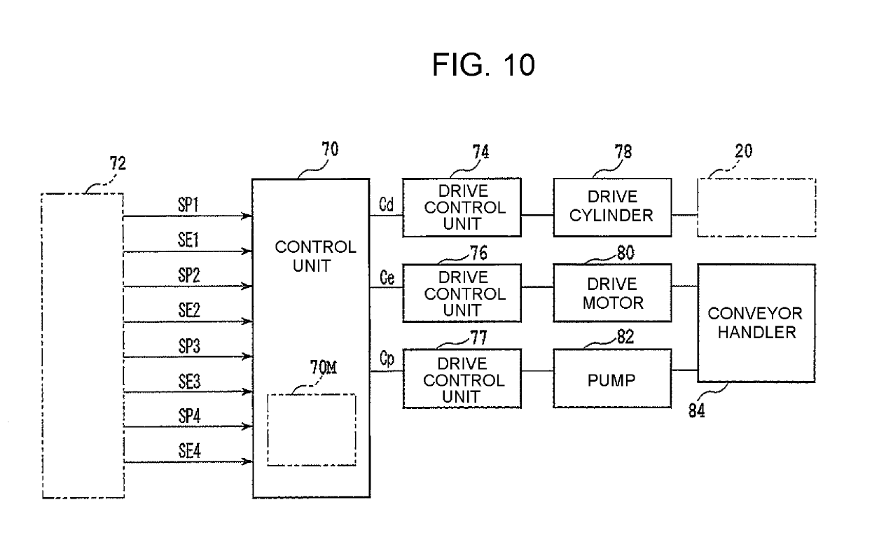

Referring to, e.g., FIG. 1, a separating device 10 disposed in the separating station is configured including a base 12 having a pair of opposing stopper members 12P, a ring-like stage member 16 on which the conjoined body 28 is mounted in a predetermined position, a pressing mechanism 20 including a pressing member 18 that presses or releases the transfer master 22 of the conjoined body 28 mounted on the mounting surface of the stage member 16, a drive cylinder 78 (refer to FIG. 10) that drives the pressing mechanism 20, a receiving member 12C provided in the central portion of the base 12 that moves in concert with the pressing member 18 via a through hole 16a (see FIG. 2) of the stage member 16, receives the central portion of the transfer master 22 from below the mounting surface of the stage member 16, and causes a magnetic recording medium 24 to separate from the transfer master 22, and two coil springs 14 that bias the stage member 16 in a direction away from the receiving member 12C, as shown in FIGS. 1 and 2.

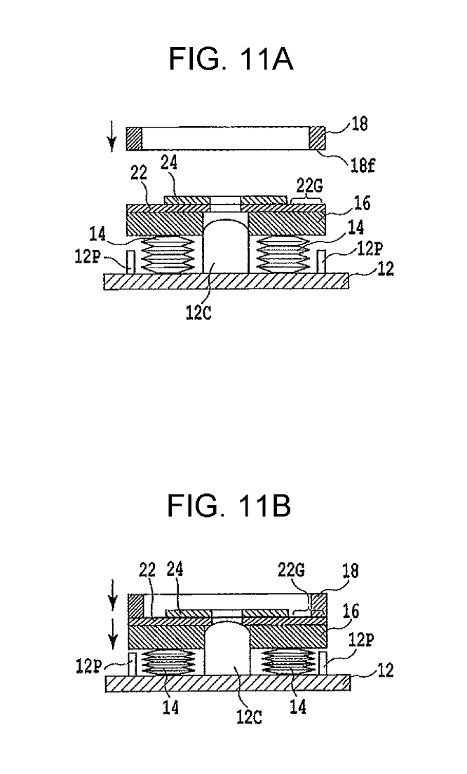

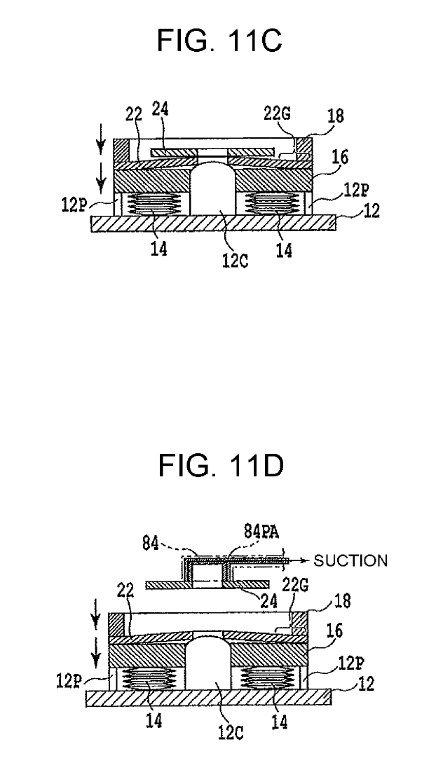

The pair of stopper members 12P have the same diameter and length as each other, and are provided in such a way that their central axes are approximately perpendicular to the surface of the base 12. Not being limited to such an example, for example, the diameters of the pair of stopper members 12P may also differ from each other. The length of the stopper member 12P to its upper end from the surface of the base 12 is set so that, when the lower surface of the pushed down stage member 16 is brought into contact with the upper end of the stopper member 12P, the upper end of the receiving member 12C protrudes by a predetermined amount from the through hole 16a of the stage member 16, causing the central portion of the transfer master 22 to bow by a predetermined amount, for example, 100 (μm), in a convex form in an upward direction, as shown in FIGS. 11C and 11D.

The length of the stopper member 12P to its upper end from the surface of the base 12 is set so that the amount of bowing of the central portion of the transfer master 22 exceeds 100 (μm) when the diameter of the transfer master 22 exceeds 80 mm, and the length of the stopper member 12P to its upper end from the surface of the base 12 is set so that the amount of bowing of the central portion of the transfer master 22 is less than 100 (μm) when the diameter of the transfer master 22 is less than 80 mm.

However, it is necessary that the bending stress (=M/Z, M: bending moment, Z: section modulus) acting on the transfer master 22 when the transfer master bows is less than the allowable bending strength of the transfer master 22.

The diameter of the receiving member 12C is set so as to be slightly smaller than the diameter of the hole 16a of the stage member 16 and, for example, approximately 1 mm larger than the diameter of the hole 22a of the transfer master 22. Also, the leading edge of the receiving member 12C is inserted into the hole 16a of the stage member 16 when the conjoined body 28 is mounted on the mounting surface of the stage member 16, as shown in FIG. 1.

The stage member 16 is supported by the two coil springs 14 disposed below it in such a way that it can move up and down. The two coil springs 14 are disposed opposed, one either side of the receiving member 12C. The quantity of the coil springs 14 not being limited to two, three or more may be provided.

The outer diameter of the ring-like pressing member 18 is set so as to be approximately the same as the outer diameter dimension of the transfer master 22. A pressing surface 18f (see FIG. 11A) of the pressing member 18 is disposed opposed to a press receiving surface portion 22G of the transfer master 22. The area of the pressing surface 18f of the pressing member 18 is set to be smaller than the area of the press receiving surface portion 22G of the transfer master 22.

When the pressing mechanism 20 is put into an operating condition, the pressing member 18 is disposed in a predetermined waiting position above the press receiving surface portion 22G of the transfer master 22, or in a position in which the pressing surface 18f thereof is brought into contact with and presses the press receiving surface portion 22G of the transfer master 22.

Referring to FIG. 10, the production system of the magnetic recording medium to which is applied the one example of the magnetic recording medium manufacturing method according to the invention includes a control unit 70 in addition to the separating device.

A command signal SP1 representing a command to start a separating operation for the conjoined body 28 supplied nth (n: n is one or more) in order to the separating device, a command signal SP2 representing a command to start a separating operation for the conjoined body 28 supplied (n+1)st in order to the separating device, a command signal SP3 representing a command to start a separating operation for the conjoined body 28 supplied (n+2)nd in order to the separating device, a command signal SP4 representing a command to start a separating operation for the conjoined body 28 supplied (n+3)rd in order to the separating device, an operation complete signal SE1 representing the completion of the separating operation for the conjoined body 28 supplied nth in order to the separating device, an operation complete signal SE2 representing the completion of the separating operation for the conjoined body 28 supplied (n+1)th in order to the separating device, an operation complete signal SE3 representing the completion of the separating operation for the conjoined body 28 supplied (n+2)nd in order to the separating device, and an operation complete signal SE4 representing the completion of the separating operation for the conjoined body 28 supplied (n+3)rd in order to the separating device are supplied to the control unit 70 from a production control host computer 72.

The control unit 70 includes a data storage unit 70M that stores operation control program data of the pressing mechanism 20 including the pressing member 18, operation control program data of a conveyor handler 84 for conveying the detached magnetic recording medium 24 to another station, data representing the set quantity n of the conjoined bodies 28 for which the separating operation is to be carried out, and the like.

The control unit 70, based on the command signal SP1 from the production control host computer 72, forms a control signal Cd in order to cause the pressing member 18, which is in the waiting position as shown in FIG. 11A, to press by a predetermined amount in a downward direction against the elastic force of the two coil springs 14, in a condition in which the pressing member 18 is in contact with the press receiving surface portion 22G of the transfer master 22 of the conjoined body 28 positioned in the predetermined position on the mounting surface of the stage member 16, as shown in FIGS. 11B and 11C, and supplies the control signal Cd to a drive control unit 74. The drive control unit 74 forms a drive signal based on the control signal Cd, and supplies it to a pump unit linked to a drive cylinder 78 in the pressing mechanism 20. By this means, the pressing surface 18f of the pressing member 18, in a condition in which it is in contact with the press receiving surface portion 22G of the transfer master 22, presses until the lower surface of the stage member 16 is brought into contact with the upper end of the stopper member 12P, as shown in FIG. 11C.

Consequently, as the central portion of the transfer master 22 is received by the hemispherical leading edge of the receiving member 12C, and caused to bow convexly in an upward direction, in a condition in which the press receiving surface portion 22G of the transfer master 22 is restrained by the pressing surface 18f of the pressing member 18, the outer periphery of the magnetic recording medium 24 in the conjoined body 28 is easily separated from the transfer receiving medium contact region 22PS of the transfer master 22 in such a way that a predetermined gap is formed. That the separation is so easy is because the resilience of the magnetic recording medium 24 itself, arising in accordance with the bending moment acting on the transfer master 22, is greater than the adherence between the magnetic recording medium 24 and transfer master 22 in the conjoined body 28. At this time, there is no danger of damage to the recording surface of the magnetic recording medium 24 or transfer receiving medium contact region 22PS of the transfer master 22.

Then, the control unit 70, based on the operation complete signal SE1, forms a control signal Ce in order to cause the detached magnetic recording medium 24 to be conveyed to the next operating station while being suction-held by the conveyor handler 84 (refer to FIG. 10), as shown in FIG. 11D, supplies the control signal Ce to a drive control unit 76, and also forms a control signal Cp, and supplies it to an air pressure control unit 77. The drive control unit 76 forms a drive control signal based on the control signal Ce, and supplies it to a drive motor 80 that causes the conveyor handler 84 to move up and down. Also, the air pressure control unit 77 forms a drive control signal based on the control signal Cp, and supplies it to a vacuum pump 82. The vacuum pump 82, when put into an operating condition, suction holds the magnetic recording medium 24 with the gripping surface of the conveyor handler 84 through an operating pressure supply passage 84PA (see FIG. 11, e.g.) inside the conveyor handler 84.

Consequently, the conveyor handler 84 is caused to descend so as to approach the detached magnetic recording medium 24 and, after holding the magnetic recording medium 24, caused to rise so as to move away, and conveys the magnetic recording medium 24 to the next operating station.

Continuing, the control unit 70, based on the command signal SP2 and operation complete signal SE2, command signal SP3 and operation complete signal SE3, and command signal SP4 and operation complete signal SE4, causes the separating device 10 and conveyor handler 84 to carry out the same kinds of operation as the operations heretofore described for the conjoined bodies 28 sequentially supplied (n+1)st, (n+2)nd, and (n+3)rd in order.

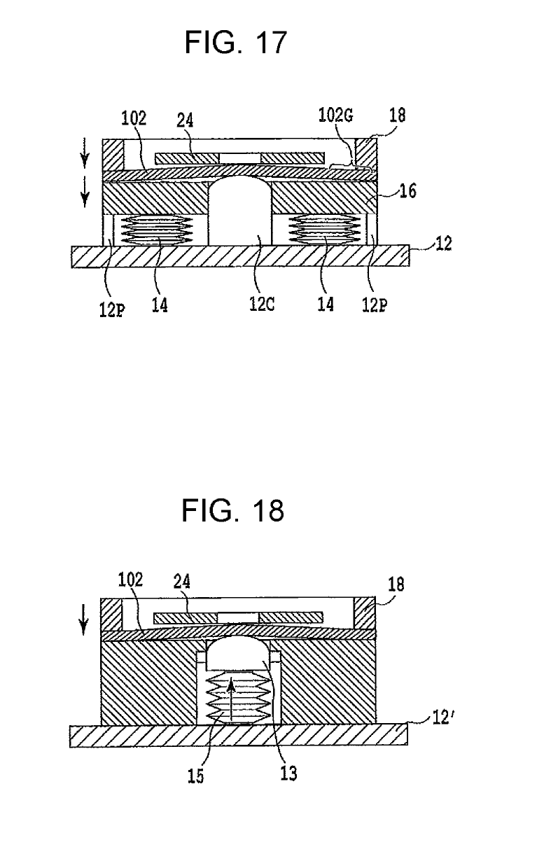

In the heretofore described example, the transfer master 22 has, for example, the circular hole 22a in the central portion but, not being limited to such an example, for example, a disc-like transfer master 102 having a ring-like press receiving surface portion 102G, and with no hole in the central portion, may also be used, as shown in FIG. 17.

Because of this, as the transfer master 102 does not need any internal hole processing, there is an advantage in that the manufacturing cost of the transfer master 102 can be reduced.

Further still, not being limited to the disc-like transfer master 22, for example, a rectangular transfer master 104 having a ring-like transfer receiving medium contact region 104G, as shown in FIG. 20, may also be used. In such a case, a length Lm of one side of the transfer master 104 is set to be greater than a diameter Ls of the magnetic recording medium 24. Because of this, as it is possible to utilize, for example, a rectangular quartz substrate used as a semiconductor blank mask, there is an advantage in that the manufacturing cost of the transfer master can be reduced.

In the heretofore described example, the production system includes one conjoined body formation device, one magnetic transfer device, and one separating device in each operating station but, not being limited to such an example, the production system may be such as to include, for example, one conjoined body formation device, two magnetic transfer devices, and one separating device in each operating station.

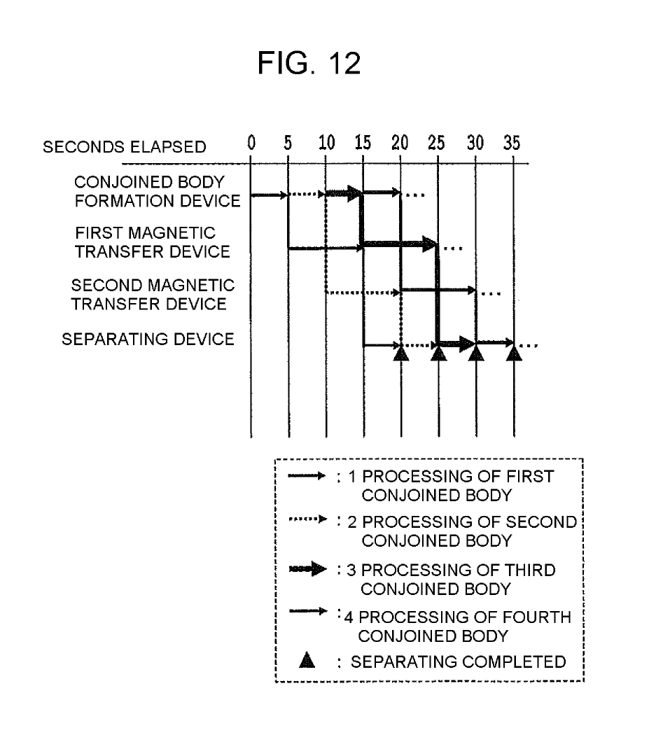

With this kind of production system, for example, it is possible to carry out the conjoined body formation step, the magnetic transfer step, and the conjoined body separating step consecutively for a plurality (four in FIG. 12) of transfer receiving media, and consecutively manufacture transfer receiving media to which a magnetic transfer has been made, as shown in FIG. 12. Under conditions of five seconds for the conjoined body formation step, ten seconds for the magnetic transfer step, and five seconds for the conjoined body separating step, magnetic transfer media can be consecutively manufactured at a speed of one every five seconds.

Specifically, while a magnetic transfer is being carried out in a first magnetic transfer device for a first conjoined body formed in the conjoined body formation device, a new second conjoined body is formed in the conjoined body formation device, the second conjoined body is conveyed to a second magnetic transfer device, and a transfer is carried out. Next, on the transfer for the first conjoined body finishing in the first magnetic transfer device, the first conjoined body is conveyed to the separating device, and a new third conjoined body formed in readiness is supplied to the first magnetic transfer device.

Continuing, on the transfer for the second conjoined body finishing in the second magnetic transfer device, the second conjoined body is conveyed to the separating device, and a new fourth conjoined body formed in readiness is supplied to the second magnetic transfer device. In this way, it is possible to consecutively manufacture transfer receiving media to which a magnetic transfer has been made.

Consequently, as the magnetic transfer device and separating device are of separate configurations, it is sufficient to combine the number of magnetic transfer devices (two) and separating devices (one) necessary to manufacture at a speed of one every five seconds, and it is possible to consecutively manufacture magnetic transfer media with a simpler device configuration, and at the same speed as heretofore known.

### Second Embodiment

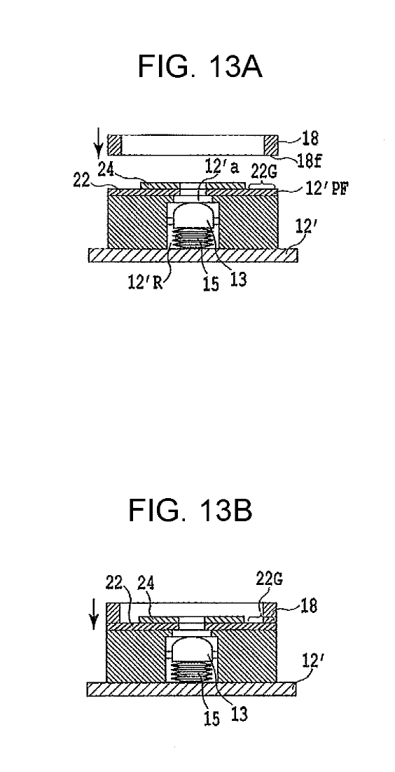

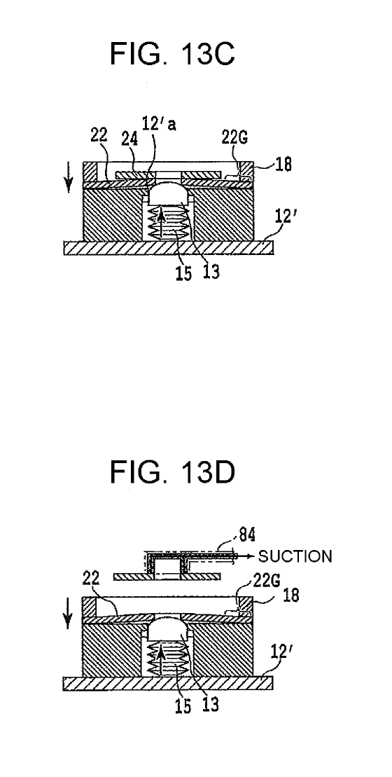

FIGS. 13A to 13D schematically show a configuration of a second embodiment of the separating device disposed in the separating station in the production system of the magnetic recording medium to which is applied one example of the magnetic recording medium manufacturing method according to the invention. In FIGS. 13A to 13D, components the same as components in the example shown in FIG. 1 are given the same reference numerals and characters, and a redundant description is omitted. Also, with regard to the configurations of each operating station other than the separating station, and of the control unit, the second embodiment includes the same configurations as those of the examples shown in FIGS. 4A, 4B, 6, and 10.

In the example shown in FIG. 1, the receiving member 12C is fixed to the base 12, and the stage member 16 is movable in relation to the receiving member 12C, but instead of that, in FIGS. 13A to 13D, a receiving member 13 that presses the central portion of the transfer master 22 mounted on the upper end surface (mounting surface) of a base 12′ from below the mounting surface is disposed so as to be able to move up and down inside a depressed portion 12′R formed in the central portion of the base 12′.

In FIGS. 13A to 13D, the separating device is configured including the base 12′, which has in its upper portion the mounting surface on which the transfer master 22 of the conjoined body 28 is mounted, and has inside the depressed portion 12′R communicating with a hole 12′a in the center of the upper portion, the pressing mechanism 20 including the pressing member 18 that presses or releases the transfer master 22 of the conjoined body 28 mounted on a mounting surface 12′PF of the base 12′, the drive cylinder 78 (refer to FIG. 10) that drives the pressing mechanism 20, the receiving member 13, provided so as to be able to move up and down inside the depressed portion 12′R of the base 12′, that moves in concert with the pressing member 18 via the hole 12′a, presses the central portion of the transfer master 22 from below the mounting surface 12′PF, and causes the magnetic recording medium 24 to separate from the transfer master 22, and an up-down mechanism 15 formed including a coil spring that biases the receiving member 13 in an upward direction.

The up-down mechanism 15 is linked to the output shaft of a drive motor, omitted from the drawings, and includes a configuration wherein, when the drive motor is put into an operating condition, the receiving member 13 is caused to rise when the output shaft is caused to rotate in one direction, while the receiving member 13 is caused to descend against the elastic force of the coil spring when the output shaft is caused to rotate in the other direction.

The control unit 70, based on, for example, the command signal SP1 from the production control host computer 72, forms the control signal Cd in order to cause the pressing member 18, which is in the waiting position as shown in FIG. 13A, to be lowered so as to come into contact with the press receiving surface portion 22G of the transfer master 22 of the conjoined body 28 positioned in a predetermined position on the mounting surface 12′PF of the base 12′, as shown in FIGS. 13B and 13C, and supplies the control signal Cd to the pump unit linked to the drive cylinder 78. Also, the control unit 70 supplies a control signal to a drive control unit that controls the drive motor of the up-down mechanism 15 in order to cause the receiving member 13 to rise by a predetermined amount.

Consequently, as the central portion of the transfer master 22 is pressed by the hemispherical leading edge of the receiving member 13, and caused to bow convexly in an upward direction, in a condition in which the press receiving surface portion 22G of the transfer master 22 is restrained by the pressing surface 18f of the pressing member 18, the outer periphery of the magnetic recording medium 24 in the conjoined body 28 is easily separated from the transfer receiving medium contact region 22PS of the transfer master 22 in such a way that a predetermined gap is formed. That the separation is so easy is because the resilience of the magnetic recording medium 24 itself, arising in accordance with the bending moment acting on the transfer master 22, is greater than the adherence between the magnetic recording medium 24 and transfer master 22 in the conjoined body 28. At this time, there is no danger of damage to the recording surface of the magnetic recording medium 24 or transfer receiving medium contact region 22PS of the transfer master 22.

Also, with such an example, there is an advantage in that it is easily possible to adjust the stroke of the pressing member 18 and receiving member 13 in the separating device. As opposed to the first embodiment in which, as there are a plurality of stoppers 12P and the stoppers 12P and receiving member 12C are not integrated, the amount by which the stage 16 is lowered has to be obtained by calculation and adjusted, in such an example, the adjustment is easy because it is possible to directly determine the amount by which the receiving member 13 is raised by adjusting the amount of movement of the receiving member 13 in the up-down mechanism 15.

In the heretofore described example, the transfer master 22 has, for example, the circular hole 22a in the central portion but, not being limited to such an example, for example, the disc-like transfer master 102 having the ring-like press receiving surface portion 102G, and with no hole in the central portion, may also be used, as shown in FIG. 18. Because of this, as the transfer master 102 does not need any internal hole processing, there is an advantage in that the manufacturing cost of the transfer master 102 can be reduced.

### Third Embodiment

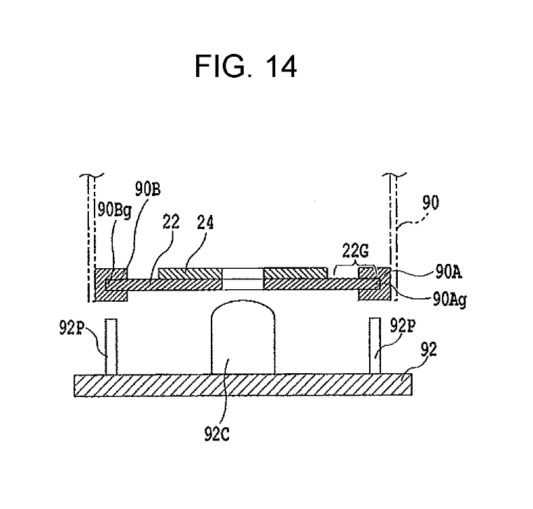

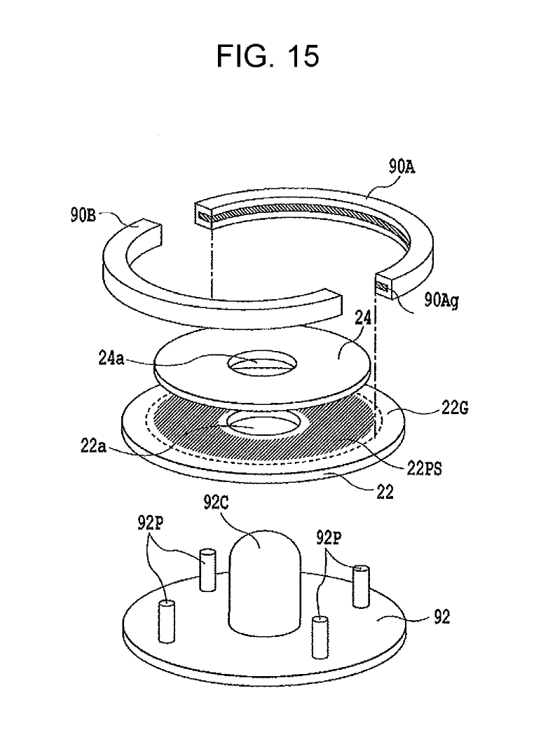

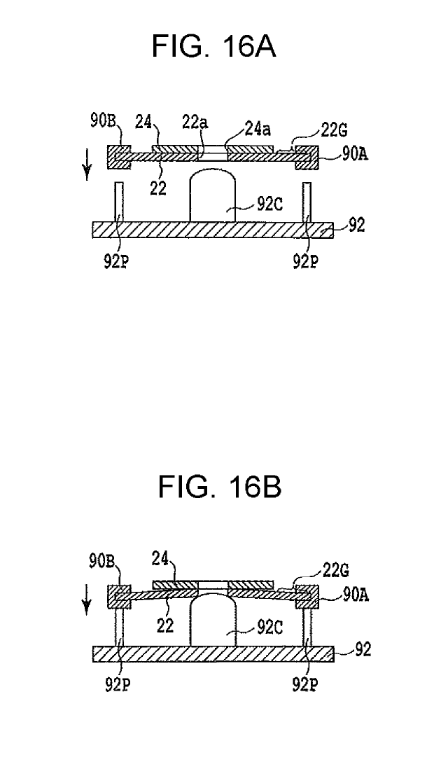

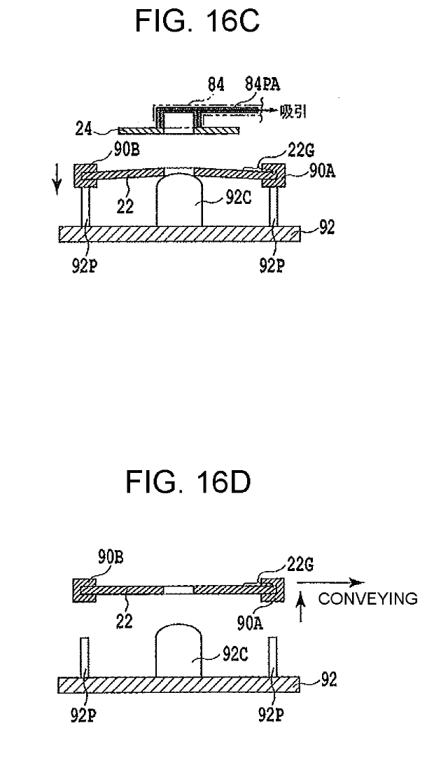

FIG. 14 schematically shows a configuration of a third embodiment of the separating device disposed in the separating station in the production system of the magnetic recording medium to which is applied one example of the magnetic recording medium manufacturing method according to the invention. In FIG. 14, in FIG. 15 and in FIGS. 16A to 16D to be described hereafter, the same reference numerals and characters are given to components the same as components in the example shown in FIG. 1, and a redundant description is omitted. Also, with regard to the configurations of each operating station other than the separating station, and of the control unit, the third embodiment includes the same configurations as those of the examples shown in FIGS. 4A, 4B, 6, and 10.

The separating device is configured including a base 92 having four stopper members 92P, a pair of clamps 90A and 90B that, moving in concert and opposed, grip the press receiving surface portion 22G of the transfer master 22 in the conjoined body 28, a pressing mechanism 90 configured including a first cylinder (not shown) that selectively causes the pair of clamps 90A and 90B to carry out an operation gripping, or an operation releasing, the press receiving surface portion 22G of the transfer master 22, and a second cylinder (not shown) that causes the pair of clamps 90A and 90B to move up and down with respect to the upper ends of the four stopper members 92P, and a receiving member 92C provided in the central portion of the base 92 that moves in concert with the pressing mechanism 90, receives the central portion of the transfer master 22 from below, and causes the magnetic recording medium 24 to separate from the transfer master 22, as shown in FIG. 15.

The four stopper members 92P have the same diameters and lengths as each other, and are provided equally spaced on a common circle in such a way that their central axis lines are approximately perpendicular to the surface of the base 92. Not being limited to such an example, the stopper members 92P may have, for example, mutually differing diameters and the same lengths. The length of the stopper member 92P to its upper end from the surface of the base 92 is set so that, when the lower surfaces of the pushed down clamps 90A and 90B are brought into contact with the upper end of the stopper member 92P, the upper end of the receiving member 92C causes the central portion of the transfer master 22 to bow by a predetermined amount, for example, 100 (μm), in a convex form in an upward direction, as shown in FIG. 16B. That is, the position of the leading edge of the hemispherical receiving member 92C is a position higher than the uppermost end of the stopper member 92P when the conjoined body 28 and clamps 90A and 90B are not in contact with the stopper member 92P, as shown in FIG. 14.

The length of the stopper member 92P to its upper end from the surface of the base 92 is set so that the amount of bowing of the central portion of the transfer master 22 exceeds 100 (μm) when the diameter of the transfer master 22 exceeds 80 mm, and the length of the stopper member 92P to its upper end from the surface of the base 92 is set so that the amount of bowing of the central portion of the transfer master 22 is less than 100 (μm) when the diameter of the transfer master 22 is less than 80 mm.

However, it is necessary that the bending stress (=M/Z, M: bending moment, Z: section modulus) acting on the transfer master 22 when the transfer master 22 bows is less than the allowable bending strength of the transfer master 22.

The receiving member 92C is disposed in an approximately central portion of the base 92, as shown in FIG. 15. The diameter of the receiving member 92C is set to be, for example, approximately 1 mm larger than the diameter of the hole 22a of the transfer master 22.

The pressing mechanism 90 is disposed in a position above the base 92. The pressing mechanism 90 is configured including the clamps 90A and 90B that selectively grip or release the transfer master 22 of the conjoined body 28, the first cylinder that causes the clamps 90A and 90B to approach or withdraw from each other, and the second cylinder that causes the pair of clamps 90A and 90B to move up and down along with the conjoined body 28 and first cylinder.

The second cylinder causes the clamps 90A and 90B, which move in concert and grip the transfer master 22 of the conjoined body 28, to adopt a waiting position above the base 92, as shown in FIG. 16A, and a pressing position in which they are brought into contact with the upper end of each stopper member 92P.

The first cylinder and second cylinder are controlled by the control unit 70 and a drive control unit respectively.

As the arced clamps 90A and 90B have the same structure as each other, a description will be given of the clamp 90A, and a description of the clamp 90B will be omitted. The clamp 90A has a groove 90Ag (90Bg for clamp 90B) into which the press receiving surface portion 22G of the transfer master 22 is fitted in such a way as to be gripped over approximately the whole of its perimeter. The radius of curvature of the elliptical groove 90Ag is set to be approximately the same as, or slightly larger than, the radius of curvature of the transfer master 22. The depth of the groove 90Ag is set to be smaller than the ring-like region of the press receiving surface portion 22G.

The control unit 70, based on the command signal SP1 from the production control host computer 72, forms a control signal Cd in order to cause the clamps 90A and 90B, which are in the waiting position as shown in FIG. 16A, to descend by a predetermined amount so as to adopt the pressing position after the central portion of the transfer master 22 of the conjoined body 28, positioned in a predetermined position so as to be concentric with the central axis line of the receiving member 92C, has come into contact with the hemispherical leading edge of the receiving member 92C, and supplies the control signal Cd to the drive control unit 74. The drive control unit 74 forms a drive signal based on the control signal Cd, and supplies it to a pump unit linked to the second cylinder in the pressing mechanism 90. By this means, the lower surfaces of the clamps 90A and 90B, in a condition in which the periphery of the hole 22a of the transfer master 22 is in contact with the hemispherical leading edge of the receiving member 92C while bowing in a convex form in an upward direction, are brought into contact with the upper end of the stopper member 92P, as shown in FIGS. 16B and 16C.

Consequently, as the central portion of the transfer master 22 is received by the hemispherical leading edge of the receiving member 92C, and caused to bow convexly in an upward direction, in a condition in which the press receiving surface portion 22G of the transfer master 22 is restrained by the clamps 90A and 90B, the outer periphery of the magnetic recording medium 24 in the conjoined body 28 is easily separated from the transfer receiving medium contact region 22PS of the transfer master 22 in such a way that a predetermined gap is formed. That the separation is so easy is because the resilience of the magnetic recording medium 24 itself, arising in accordance with the bending moment acting on the transfer master 22, is greater than the adherence between the magnetic recording medium 24 and transfer master 22 in the conjoined body 28. At this time, there is no danger of damage to the recording surface of the magnetic recording medium 24 or transfer receiving medium contact region 22PS of the transfer master 22.

Then, the control unit 70, based on the operation complete signal SE1, forms a control signal Ce in order to cause the detached magnetic recording medium 24 to be conveyed to the next operating station while being suction-held by the conveyor handler 84 (refer to FIG. 10), as shown in FIG. 16C, supplies the control signal Ce to the drive control unit 76, and also forms the control signal Cp, and supplies it to the air pressure control unit 77. The drive control unit 76 forms a drive control signal based on the control signal Ce, and supplies it to the drive motor 80 that causes the conveyor handler 84 to move up and down. Also, the air pressure control unit 77 forms a drive control signal based on the control signal Cp, and supplies it to the vacuum pump 82. The vacuum pump 82, when put into an operating condition, suction holds the magnetic recording medium 24 with the gripping surface of the conveyor handler 84 through the operating pressure supply passage 84PA inside the conveyor handler 84.

Consequently, the conveyor handler 84 is caused to descend so as to approach the detached magnetic recording medium 24 and, after holding the magnetic recording medium 24, caused to rise so as to move away, and conveys the magnetic recording medium 24 to the next operating station.

The transfer master 22 is repeatedly used by the transfer master 22 being conveyed to the conjoined body formation station again in a condition in which it is gripped by the clamps 90A and 90B (FIG. 16D). Also, provided that the structure of the pressing mechanism is such that it can grip the press receiving surface portion 22G of the transfer master 22, and also carry out the actions necessary for the separation, the heretofore described kind of method is not limiting. In such an example, as the clamps 90A and 90B, which perform the role of the gripping portion of the conveyor handler for conveying the conjoined body 28 in the way heretofore described, can also combine with this the role of the pressing member of the pressing mechanism 90, there is an advantage in that it is possible to make the device configuration simpler.

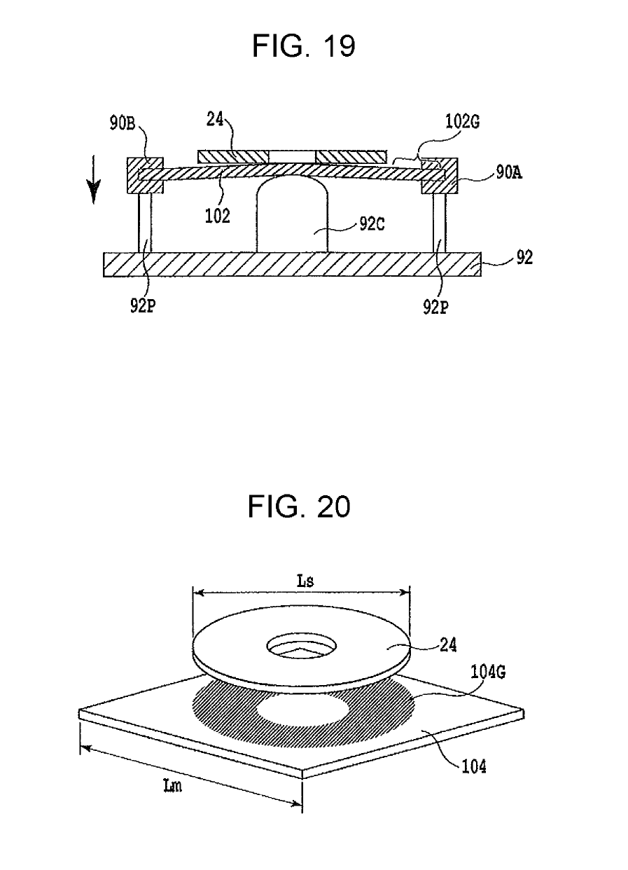

Furthermore, in the heretofore described example, the transfer master 22 has, for example, the circular hole 22a in the central portion but, not being limited to such an example, for example, the disc-like transfer master 102 having the ring-like press receiving surface portion 102G, and with no hole in the central portion, may also be used, as shown in FIG. 19. Because of this, as the transfer master 102 does not need any internal hole processing, there is an advantage in that the manufacturing cost of the transfer master 102 can be reduced.

Defects in the recording surface of one magnetic recording medium 24 detached and obtained by each of the first embodiment, second embodiment, and third embodiment, and a comparison example 1 to be described hereafter, of the separating device disposed in the separating station in the production system of the magnetic recording medium to which is applied one example of the magnetic recording medium manufacturing method according to the invention have been examined by the inventor.

The examination is such that the number of detected defects in a predetermined outer peripheral region (for example, a region with a radius of 30 mm to 32 mm) of the recording surface of the magnetic recording medium 24 is found by being observed with an optical appearance inspection device. That is, the number of defects in a predetermined outer peripheral region (for example, a region with a radius of 30 mm to 32 mm) of one transfer receiving medium 24′ is found in advance, before being brought into contact with the transfer master 22 as the conjoined body 28, the number of defects in the corresponding predetermined outer peripheral region of the recording surface of the magnetic recording medium 24 after separation is compared with the original number of defects, and the number by which the defects have increased (ΔN), and the number of each type of defect, is found. The types of defect are, for example, point defects (contaminant adhesion) and scratches of a size equal to or larger than a predetermined threshold.

The results of the examination are shown in Table 1 below.

TABLE 1

| | | Number Per Defect Type | |
|---|---|---|---|
| | ΔN | NNA | NN [symbol] |
| First Embodiment | 3 | 3 | 0 |
| Second | 1 | 1 | 0 |
| Embodiment | | | |
| Third | 2 | 2 | 0 |
| Embodiment | | | |
| Comparison | 36 | 26 | 10 |
| Example 1 | | | |

[symbol]

indicates data missing or illegible when filed

Note that, in Table 1, NA is the number of point defects (contaminant adhesions), and NB is the number of scratches.

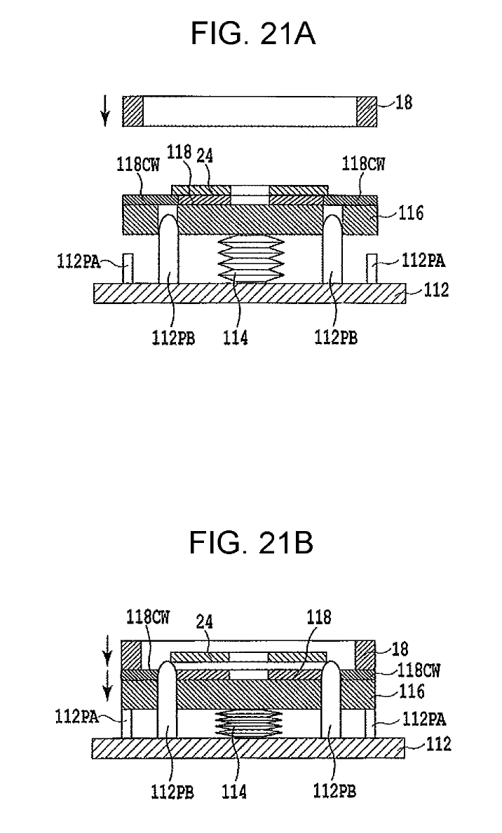

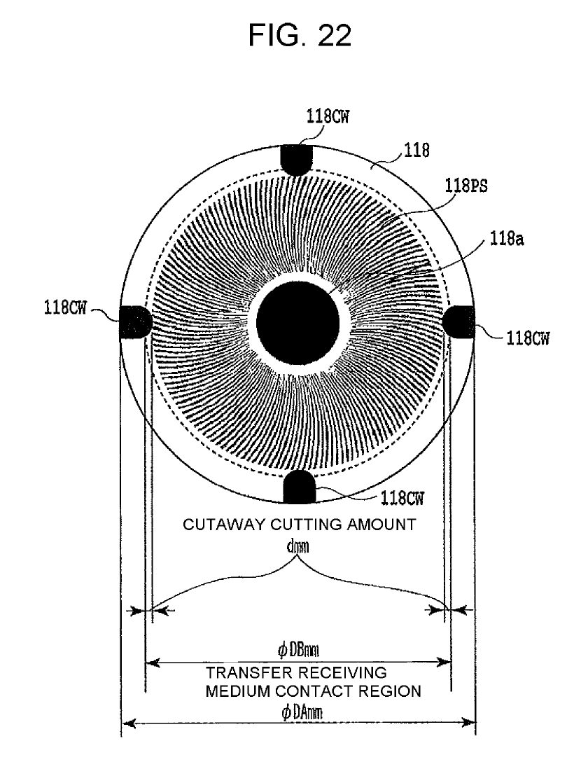

In Table 1, the kind of separating device shown in FIGS. 21A and 21B is used in the comparison example 1. Also, a transfer master 118 of the kind shown in FIG. 22 is used as the transfer master configuring the conjoined body. In FIGS. 21A and 21B, the same reference numerals and characters are given to the same components as in the example shown in FIG. 1, and a redundant description is omitted.

An outer diameter ΦDA and inner diameter ΦDC of the transfer master 118 are set at 80 mm and 20 mm respectively. Also, a transfer receiving medium contact region 118PS is formed in a ring form extending from the periphery of a hole 118a toward the outer edge of the transfer master 118 on a transfer surface of the transfer master 118. The diameter ΦDB of the transfer receiving medium contact region 118PS is set at, for example, 65 mm. The transfer receiving medium contact region 118PS has a transfer pattern formation surface configured of a plurality of arcs extending radially at predetermined intervals in a circumferential direction from the inner periphery to the outer periphery. In FIG. 22, a microscopic pattern corresponding to magnetic transfer information is formed from, for example, a soft magnetic body in each portion describing a black arc in the transfer pattern. Also, cutaway portions 118CW are formed at 90 degree intervals on a common circle in the outer peripheral edge portion of the transfer master 118. A cutting amount d of each cutaway portion 118CW, which is a portion engaged with the periphery of the magnetic recording medium 24 in a way to be described hereafter, is set at 1.5 mm. A receiving pin 112PB, to be described hereafter, is fitted into each cutaway portion 118CW when the magnetic recording medium 24 is detached.

In FIG. 21A, the separating device is configured including a base 112 having a pair of opposing stopper members 112PA, a ring-like stage member 116 on which a conjoined body including the transfer master 118 and magnetic recording medium 24 is mounted in a predetermined position, a pressing mechanism including the pressing member 18 that presses or releases the transfer master 118 of the conjoined body mounted on the mounting surface of the stage member 116, a drive cylinder (not shown) that drives the pressing mechanism, four protruding pins 112PB provided in the central portion of the base 112 that move in concert with the pressing member 18 via through holes of the stage member 116, press the outer peripheral edge of the magnetic recording medium 24 on the transfer master 118 mounted on the stage member 116 from below through the cutaway portions 118CW of the transfer master 118, and cause the magnetic recording medium 24 to separate from the transfer master 118, and a coil spring 114 that biases the stage member 116 in a direction away from the protruding pins 112PB.

In such a configuration, the periphery of the magnetic recording medium 24 is pressed by the four protruding pins 112PB protruding through the cutaway portions 118CW by the pressing surface of the pressing member 18 being pressed down while being brought into contact with the surface of the transfer master 118 in the conjoined body against the elastic force of the coil spring 114, and the magnetic recording medium 24 in the conjoined body is separated from the transfer master 118, as shown in FIG. 21B.

As is clear from the results shown in Table 1, with the magnetic recording medium 24 obtained by the first to third embodiments of the separating device disposed in the separating station in the production system of the magnetic recording medium to which is applied one example of the magnetic recording medium manufacturing method according to the invention, there is little increase in point defects, and no scratches occur. Meanwhile, in the comparison example 1, wherein the magnetic recording medium 24 is pressed directly by the leading edges of the protruding pins 112PB, it is confirmed that the increase in defects is ten times or more greater than in the first to third embodiments, and that a large number of scratches occur.

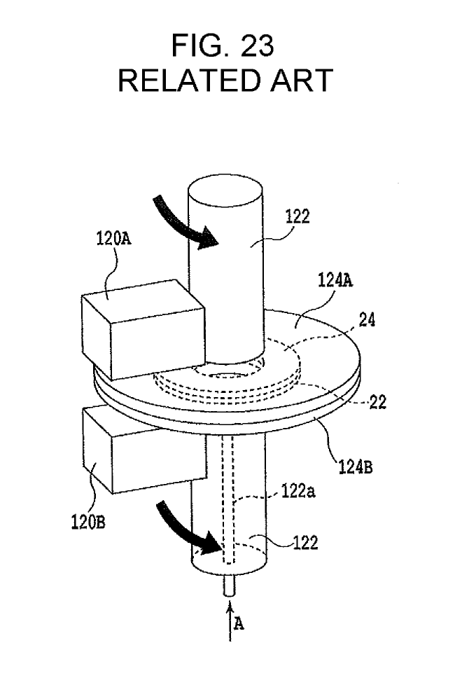

A case of consecutively manufacturing magnetic transfer media utilizing the kind of heretofore known magnetic transfer device shown in FIG. 23 having chamber formation members 124A and 124B is considered as another comparison example. In FIG. 23, a conjoined body including the transfer master 22 and magnetic recording medium 24 is stored in a chamber formed inside the detachably linked chamber formation members 124A and 124B in the device. A gas of a predetermined pressure is supplied to the conjoined portion of the transfer master 22 and magnetic recording medium 24 in the chamber through an operating pressure supply passage 122a formed inside a spindle 122, to be described hereafter. Also, one end of the spindle 122 is linked to the central portion of the chamber formation members 124A and 124B. Then, a magnetic transfer is carried out onto the magnetic recording medium 24 by electromagnets 120A and 120B put into an operating condition while the spindle 122 is caused to rotate.

Subsequently, the magnetic recording medium 24 is separated from the transfer master 22 by the gas of the predetermined pressure being fed into the chamber through the operating pressure supply passage 122a in the direction shown by an arrow A.

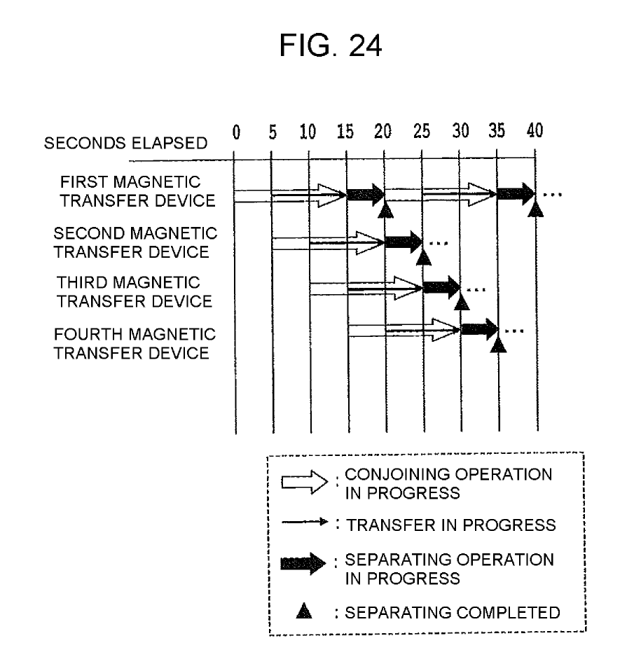

For example, consideration is given to a case of consecutively manufacturing magnetic transfer media at a speed of one every five seconds under conditions of five seconds for the conjoined body formation step, ten seconds for the magnetic transfer step, and five seconds for the separating step, as shown in FIG. 24.

With the kind of heretofore known magnetic transfer device shown in FIG. 23, as the magnetic transfer step and conjoined body separating step are carried out with one device, it is not possible to carry out the next magnetic transfer step while separating the conjoined body. Therefore, it can be understood that four of the heretofore known magnetic transfer devices combining the magnetic transfer step and conjoined body separating step are needed, as shown in FIG. 24.

It will be apparent to one skilled in the art that the manner of making and using the claimed invention has been adequately disclosed in the above-written description of the exemplary embodiments taken together with the drawings. Furthermore, the foregoing description of the embodiments according to the invention is provided for illustration only, and not for limiting the invention as defined by the appended claims and their equivalents.

It will be understood that the above description of the exemplary embodiments of the invention are susceptible to various modifications, changes and adaptations, and the same are intended to be comprehended within the meaning and range of equivalents of the appended claims.

What is claimed is:

1. A magnetic recording medium manufacturing method comprising:
a step of forming a conjoined body including a transfer master on which magnetic transfer information is recorded, and a transfer receiving medium; and
a separating step causing the transfer receiving medium in the conjoined body to separate from the transfer master, wherein
the transfer receiving medium is caused to separate from the transfer master in the separating step by pressing at least one of an outer peripheral edge portion or a central portion of the transfer master, causing the transfer master to bow in a convex form.

2. The magnetic recording medium manufacturing method according to claim 1, wherein the transfer receiving medium is caused to separate from the transfer master in the separating step by pressing the outer peripheral edge portion of the transfer master with the central portion of the transfer master acting as a fulcrum, causing the transfer master to bow in a convex form.

3. The magnetic recording medium manufacturing method according to claim 1, wherein
the transfer receiving medium is caused to separate from the transfer master in the separating step by pressing the central portion of the transfer master with the outer peripheral edge portion of the transfer master acting as a fulcrum, causing the transfer master to bow in a convex form.

4. The magnetic recording medium manufacturing method according to claim 1, wherein
a gripping portion of a conveyor handler for conveying the conjoined body also performs the role of a pressing member of a pressing mechanism that presses at least one of the outer peripheral edge portion or the central portion of the transfer master.

5. The magnetic recording medium manufacturing method according to claim 1, further comprising:
a magnetic transfer step of carrying out a magnetic transfer based on magnetic transfer information onto the transfer receiving medium in the conjoined body, using a magnetic field generating unit, wherein
the separating step and magnetic transfer step are carried out in different operating stations.

6. A magnetic recording medium manufactured by using the magnetic recording medium manufacturing method according to claim 1.

7. The magnetic recording medium manufacturing method according to claim 1, wherein
a resilience of the transfer receiving medium arising in accordance with a bending moment acting on the transfer master of the conjoined body is greater than an adherence between the transfer master and transfer receiving medium.

8. A method comprising:
arranging a conjoined body on a separating device, the conjoined body including a magnetic recording medium and a transfer master; and
applying a pressing force to at least one of an outer periphery or a central portion of the transfer master to separate the magnetic recording medium from the transfer master.

9. The method of claim 8, wherein applying the pressing force comprises bringing a pressing member of the separating device into contact with a press receiving surface portion of the transfer master on the outer periphery of the transfer master.

10. The method of claim 8, wherein applying the pressing force comprises receiving, on a receiving member of the separating device, the central portion of the transfer master.

11. The method of claim 8, wherein applying the pressing force comprises:
bringing a pressing member of the separating device into contact with a press receiving surface portion on the outer periphery of the transfer master;
receiving, on a receiving member of the separating device, the central portion of the transfer master; and
causing, by the pressing force, the transfer master to bow convexly while the press receiving surface portion is restrained by the pressing member.

12. The method of claim 11, further comprising conveying the separated magnetic recording medium to an operating station.

13. An apparatus, comprising;
a stage member to hold a conjoined body including a magnetic recording medium and a transfer master;
a receiving member; and
a pressing mechanism including a pressing member, the pressing mechanism configured to bring the pressing member into contact with an outer periphery of the transfer master, and bring the receiving member into contact with a central portion of the transfer master, and apply a pressing force to cause the transfer master to bow convexly to separate the magnetic recording medium from the transfer master.

14. The apparatus of claim 13, further comprising at least one biasing member to bias the stage member away from the receiving member.

15. The apparatus of claim 13, further comprising at least one stopper member to contact a lower surface of the stage member when the stage member is pushed down by the pressing member.
